(19) United States
(12) Patent Application Publication
(10) Pub. No.: US 2007/0131095 A1
(43) Pub. Date: Jun. 14, 2007

(54) Method of classifying music file and system therefor

(75) Inventors: Gun-han Park, Suwon-si (KR); Sang-yong Park, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/594,097

(22) Filed: Nov. 8, 2006

(30) Foreign Application Priority Data
Dec. 10, 2005 (KR) 10-2005-0121252

(51) Int. Cl. G10H 7/00; A63H 5/00; G04B 13/00

(52) U.S. Cl. 84/609

(57) ABSTRACT

A method which allows multimedia players to analyze features of a music file so as to classify the music file, and a system therefor are provided. The method of classifying a music file includes pre-processing to decode and normalize at least a part of an input music file, extracting one or more features from the pre-processed data, and determining the mood of the input music file using the extracted features.

### CROSS-REFERENCE TO RELATED PATENT APPLICATION

This application claims priority from Korean Patent Application No. 10-2005-0121252, filed on Dec. 10, 2005, in the Korean Intellectual Property Office, the disclosure of which is incorporated herein in its entirety by reference.

### BACKGROUND OF THE INVENTION

1. Field of the Invention

Methods consistent with the present invention relate to an analysis of a music file, and more particularly, to a method which allows multimedia players (i.e. computers, MP3 players, portable multimedia players (PMPs), etc.) to analyze features of a music file so as to classify the file's musical mood, and a system therefor.

2. Description of the Related Art

With the development of related art multimedia techniques, interest in the classification of music has been increasing. However, related art methods of classifying and searching for music files using text-based audio information have some problems. Related art text-based search techniques have been well developed and have excellent performance, but when dealing with large quantities of audio data, it is very difficult to create text-based audio information for all music files. Even if the text data is created, it is difficult to maintain the consistency of the text data, because text formats vary depending on who creates the data.

For at least this reason, computer-based automatic music classification has been researched. Whether it is performed by humans or computers, music classification is a difficult task, because musical mood depends greatly on personal taste and various factors such as culture, education, and experience. However, in spite of this ambiguity, automatic music classification is faster and more consistent than human-based music classification. Since computer-based music classification can avoid personal preference and prejudice, an automatic mood classification method for music is actively being researched.

Related art research on automatic mood classification for music has used speech recognition techniques such as a spectral method, a temporal method, and a cepstral method. The spectral method uses features such as a spectral centroid, or a spectral flux. The temporal method uses features such as a zero crossing rate. The cepstral method uses features such as Mel-frequency cepstral coefficients (MFCCs), linear prediction coding (LPC), and a cepstrum. However, there is no related art automatic mood classification method for music that achieves improved speed and improved accuracy.

### SUMMARY OF THE INVENTION

The present invention provides a method which can improve the speed and accuracy of musical mood classification by using extracted audio features and a system therefor.

A method for classifying a music file and a system therefor are provided, by analyzing a part of a music piece instead of analyzing overall statistical values for the music piece, and extracting features that give better performance than existing features used for related art classification methods, and which uses a support vector machine (SVM), which is a kernel-based machine learning method, for classification accuracy.

According to an aspect of the present invention, there is provided a method of classifying a music file comprising: pre-processing to decode and normalize at least a part of an input music file; extracting one or more features from the pre-processed data; and determining the mood of the input music file using the extracted features.

The pre-processing may comprise pre-processing the input music file for about 10 seconds starting from a specific point of the music file, which may be about 30 seconds after the beginning of the music file.

The extracting one or more features may comprise determining the features by extracting one or more values from among a spectral centroid, a spectral roll-off, a spectral flux, Bark scale frequency cepstral coefficients (BFCCs), and differences (or deltas) of coefficients among the BFCCs.

The determining the features may further comprise: dividing the pre-processed data into a plurality of analysis windows; acquiring the average and variance of the spectral centroid, the average and variance of the spectral roll-off, the average and variance of the spectral flux, and the averages and variances of the BFCCs, in units of a texture window, while shifting the texture window having a predetermined number of analysis windows by units of one analysis window; and determining the features of the overall pre-processed data by obtaining the average of the acquired averages and variances for each texture window.

In addition, the determining the mood of the input music file may comprise determining mood of the music file by using a support vector machine (SVM) classifier.

According to another aspect of the present invention, there is provided a system for classifying a music file comprising: a pre-processing unit which pre-processes at least a part of an input music file; a feature extracting unit which extracts one or more features from pre-processed data; a mood determining unit which determines the mood of the input music file by using the extracted features; and a storing unit which stores the extracted features and the determined mood.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart of a method of classifying a music file according to an exemplary embodiment of the present invention;

FIG. 2 is a block diagram of a system for classifying a music file according to an exemplary embodiment of the present invention;

FIG. 3 is a flowchart of a pre-processing method according to an exemplary embodiment;

FIG. 4 illustrates a method of moving a texture window for extracting features according to an exemplary embodiment of the present invention;

FIG. 5 illustrates the process of obtaining features according to an exemplary embodiment of the present invention; and

FIG. 6 illustrates a data format for storing features according to an exemplary embodiment of the present invention.

### DETAILED DESCRIPTION OF EXEMPLARY EMBODIMENTS OF THE INVENTION

The present invention will now be described in detail by explaining exemplary embodiments of the invention with reference to the attached drawings.

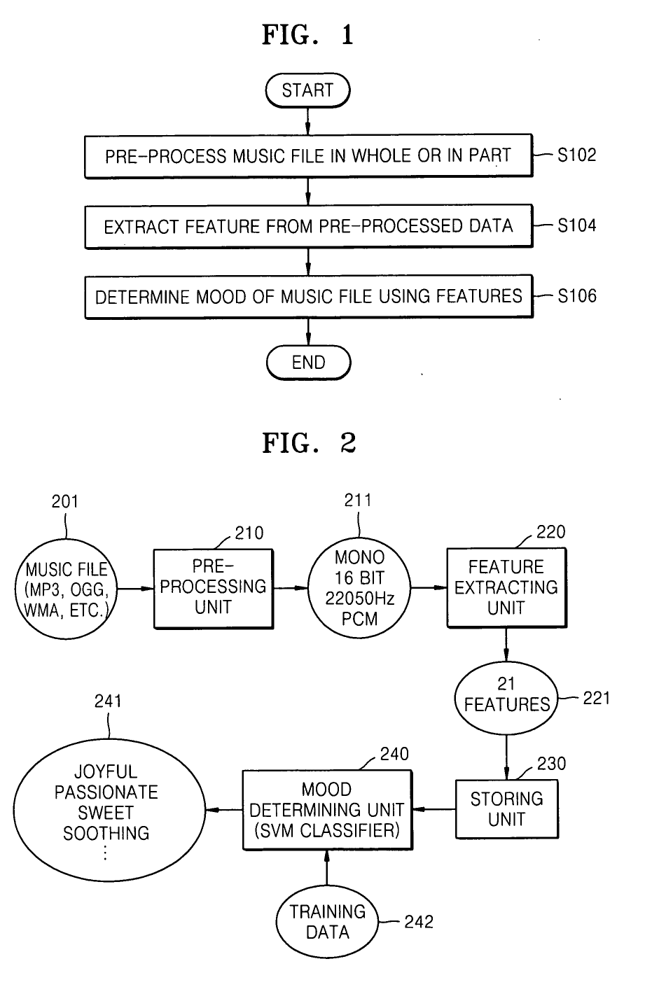

FIG. 1 is a flowchart of a method of classifying a music file according to an exemplary embodiment of the present invention.

An input music file is pre-processed in whole or in part (operation S102). Through pre-processing, a music file that is encoded in a format such as MP3, OGG, or the like is decoded and normalized. In an exemplary embodiment of the present invention, features of the music file are extracted from a part of the music file. This is because the result obtained by analyzing only a part of the music file can be as accurate as that of analyzing the full context of the music file. An exemplary analysis of a music file uses a data block from about 30 to 40 seconds after the beginning of the music file. By extracting features for about 10 seconds from the data of the music file, the time for extracting features and classifying the musical mood can be substantially reduced.

Next, one or more features are extracted from the pre-processed data (operation S104). At this time, among the extractable features of audio data, features which are deemed to be effective for classifying the musical mood are selected. Five such exemplary features are a spectral centroid, a spectral roll-off, a spectral flux, Bark scale frequency cepstral coefficients (BFCCs), and differences (or deltas) of coefficients among the BFCCs.

Finally, the musical mood of the music file is determined using the extracted features (operation S106). For this, a support vector machine (SVM) classifier may be used.

FIG. 2 is a block diagram of a system for classifying a music file according to an exemplary embodiment of the present invention. The system includes a pre-processing unit 210 for pre-processing an input music file 201, a feature extracting unit 220 for extracting one or more features of pre-processed data 211, a mood determining unit 240 for determining the mood of the input music file 201 by using training data 242 and extracted features 221, and a storing unit 230 for storing the extracted features 221 and the determined mood 241.

The input music file 201 is encoded in the format of MP3, OGG, or WMA in this exemplary embodiment of the present invention, but it is not limited thereto and may have different formats in other exemplary embodiments without departing from the scope of the invention. In addition, the input music file 201 is converted into mono pulse code modulation (PCM) data 211 at about 22,050 Hz through a series of pre-processes described below, but the data 211 may have different formats in other exemplary embodiments without departing from the scope of the invention.

The pre-processed data 211 is analyzed by the feature extracting unit 220 to output the extracted features 221. Here, a total of 21 features are extracted: the average and variance of the spectral centroid, the average and variance of the spectral roll-off, the average and variance of the spectral flux, the averages and variances of the first five coefficients of BFCCs, and five deltas of the BFCCs. In this exemplary embodiment of the present invention, features that are deemed to be effective for music classification and to best enhance performance are selected through various experiments. The extracted features 221 are stored in the storing unit 230, and are used for mood classification. The mood determining unit 240 is a SVM classifier in this embodiment. According to the SVM classifier 240, the mood 241 of the input music file 201 is determined to be “joyful”, “passionate”, “sweet”, or “soothing”. However, the exemplary embodiments are limited thereto; moreover, the number of features is not limited to 21, and any number of features as would be envisioned by one skilled in the art may be used.

A support vector machine (SVM) is a kernel-based machine learning method, and is a type of unsupervised learning method. The SVM method has a clear theoretical ground in which complex pattern recognition can be easily carried out using only simple formulas. To classify a practical complex pattern, the SVM method linearly processes a vector input space having a high order non-linear feature, and provides a maximum margin hyper-plane between each feature vector.

The SVM method may be implemented as follows. Here, a one-to-one classification method is used. For a multi-class classifier, several one-to-one classifiers are used. Training data of a positive featured class and a negative featured class is defined in Formula 1.
(x₁,y₁), . . . ,(xₖ,yₖ), xᵢεRⁿ,yᵢε+1,−1 [Formula 1]

where R is a real, n and k are integers, and xᵢ denotes an nth order feature vector of the ith sample. Here, the spectral centroid, the spectral roll-off, the spectral flux, the BFCCs, and the deltas of the BFCCs are used for xᵢ. yᵢ denotes a class label of the ith data. In an elementary SVM framework, positive featured data and negative featured data are divided into a hyper-plane of Formula 2.
(ω·x)+b=0,ωεRⁿ,xεRⁿ,bεR [Formula 2]

The SVM finds an optimum hyper-plane so that the training data can be accurately divided into the two classes. The optimum hyper-plane can be obtained by solving Formula 3.

$$Minimize Φ ( ω ) = \frac{1}{2 ( ω \cdot ω )} , \qquad [ Formula 3 ]$$

subject to yᵢ[(ω·xᵢ)−b]≧1,i=1, . . . ,k

According to a Lagrange multiplier method, Formula 4 is obtained.

$$Maximize W ( α ) = {\sum }_{i = 1}^{k} {α}_{i} - \frac{1}{2} {σ}_{i , j = 1}^{k} {α}_{i} {α}_{j} {y}_{i} {y}_{j} ( {x}_{i} \cdot {x}_{j} ) , \\ subject to {α}_{i} \geq 0 , i = 1 , … , k , and {\sum }_{i = 1}^{k} {α}_{i} {y}_{i} = 0 , \qquad [ Formula 4 ]$$

where α is a k-dimension vector and σ is a real.

The hyper-plane required for the SVM is obtained by finding coefficients which satisfy Formula 4. This is called a classifier model. Practical data values are classified by a classifier obtained by using the training data. Instead of a dot product (xᵢ, yᵢ), the SVM may use a kernel function (K(xᵢ, yᵢ)). According to which kernel is used, the obtained model may be a linear model or a non-linear model.

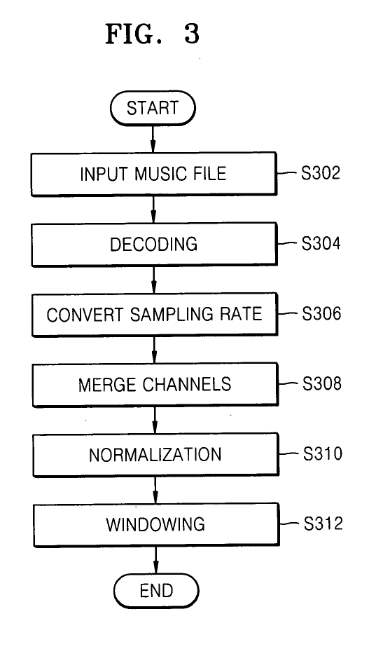

FIG. 3 is a flowchart of a pre-processing method according to an exemplary embodiment of the present invention. Several types of operations for pre-processing may be performed to remove the influence of a variety of compression formats and sampling features prior to extracting features.

First, when an encoded music file is input (operation S302), the music file is decoded to be decompressed (operation S304). Next, the music file is converted to a sampling rate (operation S306). The music file has to be converted because features are affected by the sampling rate, and useful information on the music file mostly exists in a low frequency band. Thus, the time for obtaining features can be reduced through down sampling. Channel merging is a process of changing a stereo music file to a mono music file (operation S308). By changing the stereo music file to the mono music file, a uniform feature can be obtained, and computation time can be substantially reduced. To substantially minimize the influence of loudness, sampled values are normalized (operation S310). Finally, windowing is performed (operation S312), by determining a minimum of a unit section, that is, an analysis window, to analyze features.

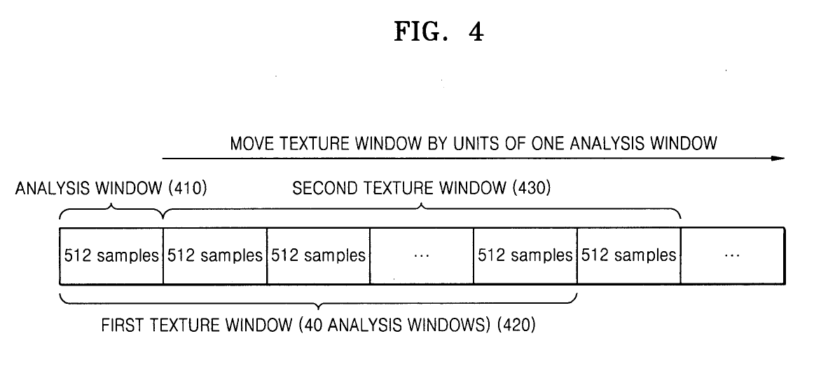

FIG. 4 illustrates a method of moving a texture window for extracting features according to an exemplary embodiment of the present invention. Features are extracted in units of an analysis window 410. Referring to FIG. 4, the analysis window 410 has a size of 512 samples. When normalized data of 22,050 Hz is used, the size of the analysis window 410 is about 23 ms. Features of a music file are estimated through a short time Fourier transform for the analysis windows. In FIG. 4, a first texture window 420 includes 40 analysis windows, and features for the texture window 420 are extracted.

After processing the first texture window 420, a second texture window 430 is processed. The second texture window 430 is shifted by one analysis window. The average and variance of features that are extracted from each analysis window included in a texture window are obtained, and the texture window is shifted by one analysis window. The averages and variances for all texture windows included in the time window to be analyzed are estimated. Then, to determine final feature values, the average of the averages for all texture windows and the average of the variances for all texture windows are obtained. The size of the analysis window and texture window affects the process of estimating. Values depicted in FIG. 4 may be determined through a variety of experiments, and may change depending on the application.

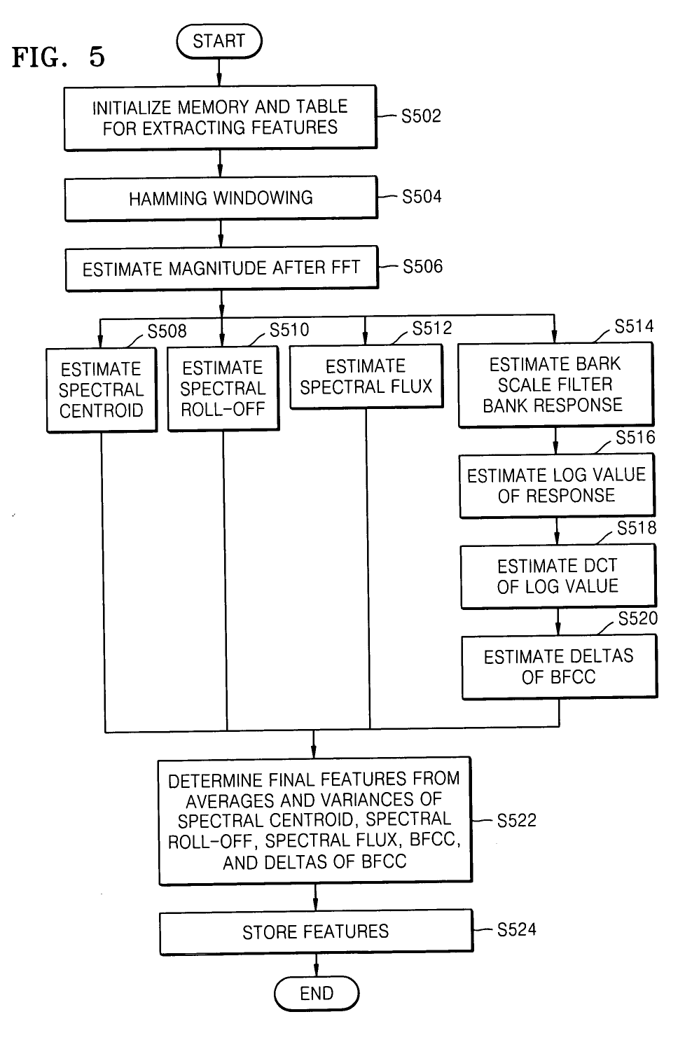

As described above, the extracted features are the average and variance of the spectral centroid, the average and variance of the spectral roll-off, the average and variance of the spectral flux, the averages and variances of the first five coefficients of BFCCs, and the deltas of the BFCCs. FIG. 5 illustrates the process of obtaining the features.

First, a memory and a table are initialized to extract the features (operation S502), and noise is removed from PCM data included in an analysis window through hamming windowing (operation S504). Data converted through the hamming windowing is converted into a frequency band through a fast Fourier transform (FFT), and thus its magnitude is obtained (operation S506). Spectral values are estimated using the magnitude, and a value of the same magnitude is passed through a Bark scale filter.

To extract a first feature, a spectral centroid is estimated (operation S508). The spectral centroid corresponds to the average of the energy distribution in a frequency band. The feature is used as a standard for recognizing musical intervals. Namely, frequencies that determine the pitch of musical sound are determined using this feature. The spectral centroid determines the frequency area where signal energy is mostly concentrated, which is estimated by Formula 5.

$${C}_{t} = \frac{{\sum }_{n = 1}^{N} {M}_{t} [ n ] * n}{{\sum }_{n = 1}^{N} {M}_{t} [ n ]} , \qquad [ Formula 5 ]$$

where N and t are integers.

Here, Mₜ[n] denotes the magnitude of a Fourier transform at a frame t and a frequency n.

To extract a second feature, a spectral roll-off is estimated (operation S510). The spectral roll-off is frequency below which about 85% of the spectral energy is distributed. The second feature is used to estimate the spectral shape, and is effectively used in distinguishing different music pieces because distribution of the energy can be represented by this feature. The different music pieces can be distinguished because energy of a music piece may be distributed widely over the entire frequency band, while energy of another music piece is distributed narrowly in the frequency band. The location of the spectral roll-off is estimated by Formula 6.

$${\sum }_{n = 1}^{{R}_{t}} {M}_{t} [ n ] = 0.85 * {\sum }_{n = 1}^{N} {M}_{t} [ n ] \qquad [ Formula 6 ]$$

A spectral roll-off frequency Rₜ is the frequency having about 85% of magnitude of distribution.

To extract a third feature, a spectral flux is estimated (operation S512). The spectral flux shows changes in energy distribution of two consecutive frequency bands. Such changes can be used to distinguish music pieces since the changes in energy distribution may vary depending on musical features. The spectral flux is defined as the square of the difference between the two consecutive normalized spectral distributions, and is estimated by Formula 7.

$${F}_{t} = {\sum }_{n = 1}^{N} {( {N}_{t} [ n ] - {N}_{t - 1} [ n ] )}^{2} \qquad [ Formula 7 ]$$

Here, Nₜ[n] denotes the normalized size of a Fourier transform at a frame t.

To extract a fourth feature, BFCCs are estimated. A BFCC scheme uses a cepstrum feature and a critical band scale filter bank which distinguishes a band that gives equal contribution to speech articulation and one of non-uniform filter banks, thereby achieving tone perception based on frequency. The aforementioned Bark scale filter based on a tone is more appropriate for music analysis than other scale filters used in subjective pitch detections. The tone represents a timbre and is a key factor in distinguishing voices and musical instruments. In the Bark scale filter, a human audible range is divided into about 24 bands. The range increases linearly at frequencies lower than a band (for example but not by way of limitation, 1,000 Hz), and increases logarithmically at frequencies higher than that band.

To estimate the BFCCs, the response of the Bark scale filter bank is estimated (operation S514). A log value of the response is estimated (operation S516), and a discrete cosine transform (DCT) of the estimated log value is estimated, thereby obtaining the BFCCs (operation S518). Deltas of the BFCCs are estimated to be determined as features (operation S520).

To determine features, the averages and variances are estimated with respect to the spectral centroid, the spectral roll-off, the spectral flux, and the BFCCs, which are estimated for a specific time window of a music piece as described above (operation S522). In the case of the BFCCs, this process may be performed for the first five coefficients of the BFCCs. Therefore, a total of 21 features are obtained. Extracted features are stored for future use in music classification or music search (operation S524).

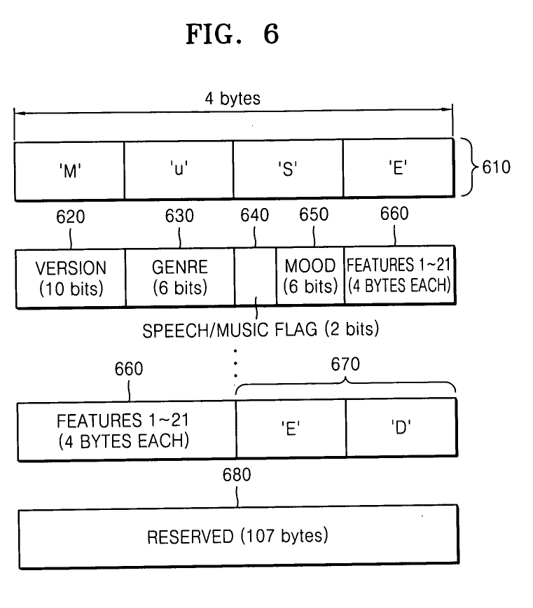

FIG. 6 illustrates an example of a data format for storing features according to an exemplary embodiment of the present invention. The data format is named “MuSE” and has a total size of 200 bytes. A 4-byte header field 610 describes a data format name, which is followed by a 10-bit version field 620, a 6-bit genre field 630, a 2-bit speech/music flag field 640, a 6-bit mood field 650, a 84-byte features field 660 having 21 features of 4 bytes, a 2-byte extension flag field 670 for indicating extension of a data format, and a 107-byte reserved data field. The version field 620 is used when the format is upgraded. The extension flag field 670 is used to add several basic data formats.

Accordingly, in the exemplary embodiment, a mood classification for a music file is automatically carried out, so that a user can select music depending on his or her mood.

In particular, since only a part of a music file is analyzed, features can be extracted about 24 times faster than by a method of analyzing the full music file. Further, overlapping spectral features are removed if they do not have an effect on performance. Also, instead of a Mel-frequency method, a Bark-frequency method is used, which can contain information on timbre, thereby substantially improving performance. Also, deltas of BFCCs are used to substantially enhance the accuracy of classification.

The exemplary embodiments can be computer programs (e.g., instructions) and can be implemented in general-use digital computers that execute the programs using a computer readable recording medium.

Although the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. A method of classifying a music file, the method comprising:
pre-processing data corresponding to a predetermined length from a predetermined position of the music file; and
classifying the music file using the pre-processed data.

2. The method of claim 1, wherein the pre-processing comprises decoding and normalizing the data corresponding to the predetermined length.

3. The method of claim 1, wherein the classifying of the music file comprises extracting at least one feature from the pre-processed data and classifying the music file by using the extracted at least one feature.

4. The method of claim 3, wherein the classifying of the music file by using the extracted at least one feature comprises classifying the music file by using a machine learning method.

5. The method of claim 4, wherein the machine learning method is a method using a support vector machine classifier.

6. The method of claim 3, wherein the extracting of the at least one feature comprises determining the at least one feature by extracting at least one value from among a spectral centroid, a spectral roll-off, a spectral flux, Bark scale frequency cepstral coefficients (BFCCs), and respective deltas of the BFCCs.

7. A system for classifying a music file, the system comprising:
a pre-processing unit which pre-processes data corresponding to a predetermined length from a predetermined position of a music file;
a feature extracting unit which extracts at least one feature from the pre-processed data;
a mood determining unit which determines a mood of the input music file by using the extracted at least one feature; and
a storing unit which stores the at least one extracted feature and the determined mood.

8. The system of claim 7, wherein the feature extracting unit determines the at least one feature by extracting at least one value from among a spectral centroid, a spectral roll-off, a spectral flux, Bark scale frequency cepstral coefficients (BFCCs), and deltas of the BFCCs.

9. The system of claim 8, wherein the feature extracting unit determines the at least one feature by:
dividing the pre-processed data into a plurality of analysis windows;
acquiring the average and variance of the spectral centroid, the average and variance of the spectral roll-off, the average and variance of the spectral flux, and the averages and variances of the BFCCs, in units of a texture window, while shifting the texture window having a number of analysis windows, by one analysis window unit; and
determining the at least one feature of the overall pre-processed data by obtaining the average of the acquired averages and variances for each texture window.

10. The system of claim 7, wherein the mood determining unit determines the mood of the music file by using a machine classifying method.

11. The system of claim 10, wherein the machine classifying method is a method using a support vector machine classifier.

12. A computer readable medium having a set of instructions for a method of classifying a music file, the instructions of the method comprising:
pre-processing data corresponding to a predetermined length from a predetermined position of the music file; and
classifying the music file using the pre-processed data.
